(19) United States
(12) Patent Application Publication
(10) Pub. No.: US 2021/0370933 A1
(43) Pub. Date: Dec. 2, 2021

(54) METHODS AND SYSTEMS FOR VALIDATING PATH DATA

(71) Applicant: HERE Global B.V., Eindhoven (NL)

(72) Inventors: Zhenhua ZHANG, Chicago, IL (US); Leon STENNETH, Chicago, IL (US)

(21) Appl. No.: 17/094,479

(22) Filed: Nov. 10, 2020

Related U.S. Application Data
(60) Provisional application No. 63/032,341, filed on May 29, 2020.

(51) Int. Cl. B60W 30/10; B60W 30/095; G08G 1/16; G06K 9/62; G06N 7/00

(52) U.S. Cl. CPC B60W 30/10; B60W 30/0956; G08G 1/167; B60W 2754/30; G06N 7/005; B60W 2554/802; G06K 9/6297

(57) ABSTRACT

The disclosure provides a method, a system, and a computer program product for validating path data for a main link path or a second link path. The method comprises receiving at least one traffic object observation based on sensor data. The method also includes extracting a plurality of path locations associated with the at least one traffic object observation. The method also includes determining an association between the plurality of path locations based on a statistical model. The method further includes generating a trajectory for the plurality of path locations based on the association and validating the path data for the main link path or the second link path, based on the generated trajectory.

### RELATED APPLICATION

This application claims priority from U.S. Provisional Application Ser. No. 63/032,341, entitled “METHODS AND SYSTEMS FOR VALIDATING PATH DATA,” filed on May 29, 2020, the contents of which are hereby incorporated herein in their entirety by this reference.

### TECHNOLOGICAL FIELD

The present disclosure generally relates to routing and navigation applications, and more particularly relates to systems and methods for validating path data for routing and navigation applications.

### BACKGROUND

Various navigation applications are available to provide assistance, for example directions for driving, walking, or other modes of travel. Web-based and mobile app-based systems offer navigation applications that allow a user to request directions from one point to another. Often, a route traversed or to be traversed by a user encompasses several links that may extend across different type of roads. For example, a route from a location that is in one part of the city to another location on an opposite end of the city may encompass traversing highways. Such highways may extend over the local roads often merging into a local road.

Generally, traffic objects which are posted on or over a road are learned using sensor data captured by vehicles. The sensor data may comprise images of a road and road surroundings and/or data thereof. Oftentimes due to a wide field-of-view of most of the image sensors, it is highly likely that traffic objects posted on other roads may also get captured by the vehicles' onboard sensors. Especially, in the context of ramps, sensors onboard the vehicle traveling on a current road may capture traffic objects posted on the ramp, in addition to the traffic objects for the current road or vice versa. As such, the vehicle may incorrectly associate the traffic object on the ramp with the current road and vice versa. Therefore, it is important to provide correct path information and accurate navigation to the vehicles.

### BRIEF SUMMARY

Accordingly, in order to provide accurate and reliable navigation assistance, it is important to validate correct path for the traffic objects. To this end, the data utilized for providing the navigation assistance should provide accurate information about traffic objects posted on a route of travel of the vehicle. Especially, in the context of navigation assistance for autonomous vehicles and semi-autonomous vehicles, to avoid inaccurate navigation, it is important that the assistance provided is real-time and accurate. Towards this end, it is essential to validate correct path for the traffic objects for autonomous vehicles and semi-autonomous vehicles to avoid inaccurate navigation. When information related to traffic objects is incorrectly captured by vehicles' sensors, this leads to erroneous data being reported to map database which is used by several navigation related applications. Such erroneous data when learnt by the map database may lead to development of an inaccurate map database which may not be suitable for providing reliable navigation assistance. More importantly, in the context of autonomous vehicles, it is of utmost importance that the navigation assistance provides correct information regarding various traffic objects present on the route of travel, such as near highway exits, ramps, intersections, road dividers and other such locations where two different paths merge or digress, and as a result, a traffic object located in the vicinity of such locations becomes a candidate for misclassification and erroneous data. Accordingly, there is a need for validating path data for a main link path or a second link path that diverges from the main link path to provide reliable navigation assistance. Example embodiments of the present disclosure provide a system, a method, and a computer program product for validating path data for a main link path or a second link path.

Some example embodiments disclosed herein provide a method for validating path data for a main link path or a second link path. The method comprises receiving at least one traffic object observation based on sensor data. The method may include extracting a plurality of path locations associated with the at least one traffic object observation. The method may further include determining, based on a statistical model, an association between the plurality of path locations, wherein the association is determined based on a connectivity probability value, a directional probability value, or a combination thereof. The method may further include generating a trajectory for the plurality of path locations based on the association, wherein the trajectory comprises either one of the main link path and the second link path. The method may further include validating the path data for the main link path or the second link path based on the generated trajectory.

According to some example embodiments, the method further comprises determining that a sensor location associated with the traffic object observation is within a first distance threshold of a first location.

According to some example embodiments, the first location is associated with a starting location of at least one of the main link path and the second link path.

According to some example embodiments, extracting the plurality of path locations comprises extracting the plurality of path locations associated with the traffic object observation based on at least one of a first criterion and a second criterion.

According to some example embodiments, the first criterion comprises determining that the extracted plurality of path locations are within a first time threshold and a second time threshold, wherein the first time threshold comprises a first predetermined time interval elapsed before a time of receiving the traffic object observation and wherein the second time threshold comprises the first predetermined time interval elapsed after the time of receiving the traffic object observation.

According to some example embodiments, wherein the second criterion comprises determining that the plurality of path locations are within the first time threshold and a second distance threshold, wherein the second distance threshold comprises a second predetermined distance measured from the first location.

According to some example embodiments, the method further comprising updating a map database based on the validated path.

According to some example embodiments, the method further comprising assigning a traffic object associated with the traffic object observation to one of the main link path or the second link path based on the validation.

According to some example embodiments, the statistical model is a Hidden Markov Model. According to some example embodiments, wherein determining the association between the plurality of path locations further comprises determining a plurality of map-matched links associated with the plurality of path locations based on the map data, wherein the plurality of map-matched are associated with a first phase and a second phase, wherein each of the first phase and the second phase correspond to a path location from the plurality of path locations; determining a transition connectivity probability value based on connectivity of the plurality of map-matched links associated with the first phase and the second phase; determining a transition directional probability value based on a degree of change in driving direction between the plurality of map-matched links associated with the first phase and the second phase; determining an emission probability value for each of the plurality of map-matched links associated with the first phase and the second phase based on a location value and a heading value of the corresponding path location associated with each of the first phase and the second phase; determining the connectivity probability value based on the transition connectivity probability value; determining the directional probability value based on the transition directional probability value; and determining the association between the plurality of path locations based on a function of the emission probability value, the connectivity probability value and the directional probability value, wherein the function is provided by the statistical model.

Some example embodiments disclosed herein provide a system for validating path data for a main link path or a second link path, the system comprising a memory configured to store computer-executable instructions and one or more processors configured to execute the instructions to receive at least one traffic object observation based on sensor data. The one or more processors are further configured to extract a plurality of path locations associated with the at least one traffic object observation. The one or more processors are further configured to determine, based on a statistical model, an association between the plurality of path locations, wherein the association is determined based on a connectivity probability value, a directional probability value, or a combination thereof. The one or more processors are further configured to generate a trajectory for the plurality of path locations based on the association, wherein the trajectory comprises either one of the main link path and the second link path and validate the path data for the main link path or the second link path based on the generated trajectory.

Some example embodiments disclosed herein provide a computer programmable product comprising a non-transitory computer readable medium having stored thereon computer executable instruction which when executed by one or more processors, cause the one or more processors to carry out operations for validating path data for a main link path or a second link path, the operations comprising receiving at least one traffic object observation based on sensor data. The operations further comprise extracting a plurality of path locations associated with the at least one traffic object observation. The operations further comprise determining, based on a statistical model, an association between the plurality of path locations, wherein the association is determined based on a connectivity probability value, a directional probability value, or a combination thereof. The operations further comprise generating a trajectory for the plurality of path locations based on the association, wherein the trajectory comprises either one of the main link path and a second link path and validating the path data for the main link path or the second link path based on the generated trajectory.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for validating path data for a main link path or a second link path, in accordance with an example embodiment;

FIG. 2 illustrates a block diagram of a system for validating path data for a main link path or a second link path, in accordance with an example embodiment;

FIGS. 3A-3B illustrate exemplary scenarios of a working example of the system for validating path data for a main link path or a second link path, in accordance with an example embodiment;

FIGS. 4A-4B illustrate exemplary representations of plurality of path locations associated with a traffic object observation, in accordance with an example embodiment;

FIG. 5 illustrates an exemplary statistical model for determining an association between the plurality of path locations, in accordance with an example embodiment, and

FIG. 6 illustrates a flow diagram of a method for validating path data for a main link path or a second link path, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “link” may be used to refer to any connecting pathway including but not limited to a roadway, a highway, a freeway, an expressway, a lane, a street path, a road, an alley, a controlled access roadway, a free access roadway and the like.

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

The term “road sign” may refer to signs positioned at the side of or above roads to provide information to road users. The road signs may include speed limit sign, street name sign, school sign, ‘men at work’ sign, a yellow lane marking, an underpass sign, an overpass sign, a road marking, or a lane marking etc.

### End of Definitions

Embodiments of the present disclosure may provide a system, a method and a computer program product for validating path data for a main link path or a second link path. A vehicle travelling on a path, such as a main link path or a second link path may encounter various traffic objects. In some example embodiments, the main link path may include a highway and the second link path may include a ramp link. The highway may be the main link on which the vehicle may be travelling at a particular instant of time. The ramp link may include, such as, an entry or exit link for the highway. In some example embodiments, the main link and the second link may be two paths diverging from an intersection point on any route of travel. In an example embodiment, the traffic objects may include a road sign, a guardrail, a traffic cone, a traffic accident and the like. The road sign may further be a speed sign or a non-speed sign. The traffic objects posted on the divergence such as a transition from a highway to a ramp entry from a main link, or from a side road from a highway makes it difficult for a vehicle to detect the correct path associated with the traffic object. For example, the traffic objects or road signs posted on the main link path may be captured by a vehicle that is about to enter a ramp and vice-versa. Often times, navigation applications may be available that may be able to identify information pertaining to the traffic object, such as location of the traffic object, a speed value associated with the traffic object in case it is a speed limit sign, or other data posted on the traffic object. But, even such applications which may accurately identify the traffic object, fail to correctly identify the path on which the traffic object is located. In such scenarios, there is need to validate the correct path associated with the traffic object to provide accurate and reliable navigation assistance. These and other technical improvements of the invention will become evident from the description provided herein.

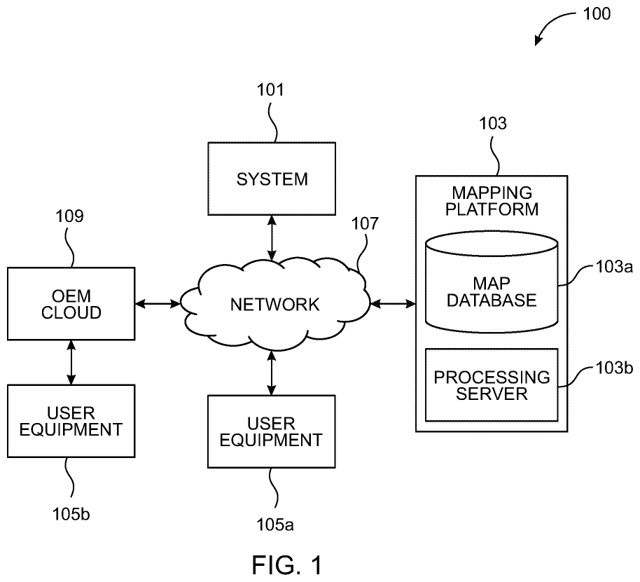

The system, the method, and the computer program product facilitating validating path data for a main link path or a second link path are described with reference to FIG. 1 to FIG. 6.

FIG. 1 illustrates a schematic diagram of a network environment 100 of a system 101 validating path data for a main link path or a second link, in accordance with an example embodiment. The system 101 may be communicatively coupled to a mapping platform 103, a user equipment 105a and an OEM (Original Equipment Manufacturer) cloud 109 connected to a user equipment 105b, via a network 107. The components described in the network environment 100 may be further broken down into more than one component such as one or more sensors or application in user equipment and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. As such, the system 101 may be configured to operate outside the user equipment 105a and/or 105b. However, in some example embodiments, the system 101 may be embodied within one or both of the user equipment 105a and the user equipment 105b, for example as a part of an in-vehicle navigation system. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. Further, in one embodiment, the system 101 may be a standalone unit configured to validate a path data for main link path or a second link path. Alternatively, the system 101 may be coupled with an external device such as the autonomous vehicle.

The mapping platform 103 may comprise a map database 103a for storing map data and a processing server 103b. The map database 103a may store traffic object observations. The traffic object observations may include sign type (such as a speed sign or a non-speed sign), a value of a sign if the sign type is a speed sign, location of the speed sign, travel direction and the heading of the speed sign. The map database 103 may store path data. The path data may include data associated with one or more of a road signs, or speed signs, or road objects on the link or path. Further, the map database 103a may store node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions. The real time traffic conditions may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In one embodiment, the map database 103a may further store historical traffic data that includes travel times, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the user equipment 105a and/or 105b. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 105a and/or the user equipment 105b to provide navigation and/or map-related functions. For example, the map database 103a may be used with the user equipment 105a and/or the user equipment 105b to provide an end user with navigation features. In such a case, the map database 103a may be downloaded or stored locally (cached) on the user equipment 105a and/or the user equipment 105b.

The processing server 103b may comprise processing means and communication means. For example, the processing means may comprise one or more processors configured to process requests received from the user equipment 105a and/or the user equipment 105b. The processing means may fetch map data from the map database 103a and transmit the same to the user equipment 105b via OEM cloud 109 in a format suitable for use by the one or both of the user equipment 105a and/or the user equipment 105b. In one or more example embodiments, the mapping platform 103 may periodically communicate with the user equipment 105a and/or the user equipment 105b via the processing server 103b to update a local cache of the map data stored on the user equipment 105a and/or the user equipment 105b. Accordingly, in some example embodiments, the map data may also be stored on the user equipment 105a and/or the user equipment 105b and may be updated based on periodic communication with the mapping platform 103.

In some example embodiments, the user equipment 105a and the user equipment 105b (hereinafter, also referred to as “the user equipment 105a, 105b”) may be any user accessible device such as a mobile phone, a smartphone, a portable computer, and the like that are portable in themselves or as a part of another portable/mobile object such as a vehicle. The user equipment 105a, 105b may comprise a processor, a memory and a communication interface. The processor, the memory and the communication interface may be communicatively coupled to each other. In some example embodiments, the user equipment 105a, 105b may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105a, 105b may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105a, 105b. Additional, different, or fewer components may be provided. For example, the user equipment 105a, 105b may be configured to execute and run mobile applications such as a messaging application, a browser application, a navigation application, and the like. In one embodiment, at least one user equipment such as the user equipment 105b may be directly coupled to the system 101 via the network 107. For example, the user equipment 105b may be a dedicated vehicle (or a part thereof) for gathering data for development of the map data in the database 103a. In some example embodiments, at least one user equipment such as the user equipment 105b may be coupled to the system 101 via the OEM cloud 109 and the network 107. For example, the user equipment 105b may be a consumer vehicle (or a part thereof) and may be a beneficiary of the services provided by the system 101. In some example embodiments, one or more of the user equipment 105a and 105b may serve the dual purpose of a data gatherer and a beneficiary device. The user equipment 105a or 105b may be configured to capture sensor data associated with a road which the user equipment 105a, 105b may be traversing. The sensor data may for example be image data of road objects, road signs, or the surroundings (for example buildings). The sensor data may refer to sensor data collected from a sensor unit in the user equipment 105a and/or user equipment 105b. In accordance with an embodiment, the sensor data may refer to the data captured by the vehicle using sensors.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 107 is coupled directly or indirectly to the user equipment 105b via OEM cloud 109. In an example embodiment, the system may be integrated in the user equipment 105b. In an example, the mapping platform 103 may be integrated into a single platform to provide a suite of mapping and navigation related applications for OEM devices, such as the user devices and the system 101. The system 101 may be configured to communicate with the mapping platform 103 over the network 107. Thus, the mapping platform 103 may enable provision of cloud-based services for the system 101, such as, storing the lane marking observations in the OEM cloud 109 in batches or in real-time.

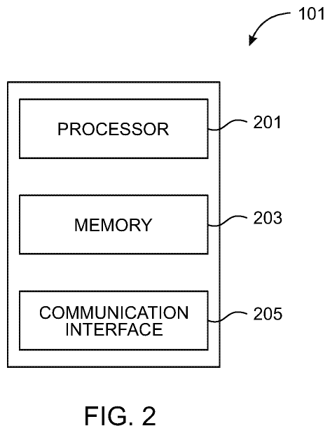

FIG. 2 illustrates a block diagram of a system 101 for validating path data for a main link path or a second link path, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the user equipment 105a, 105b or any other component with which the system 101 may communicate. The communication interface 205 may be any means such as a device or circuitry embodied in either hardware or a combination of hardware and software that is configured to receive and/or transmit data to/from a communications device in communication with the user equipment 105a, 105b. In this regard, the communication interface 205 may include, for example, an antenna (or multiple antennae) and supporting hardware and/or software for enabling communications with a wireless communication network. Additionally or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

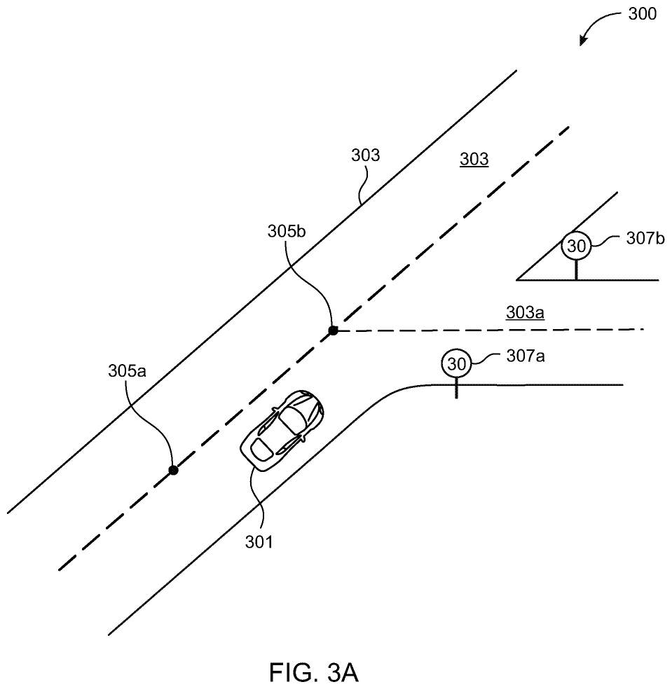

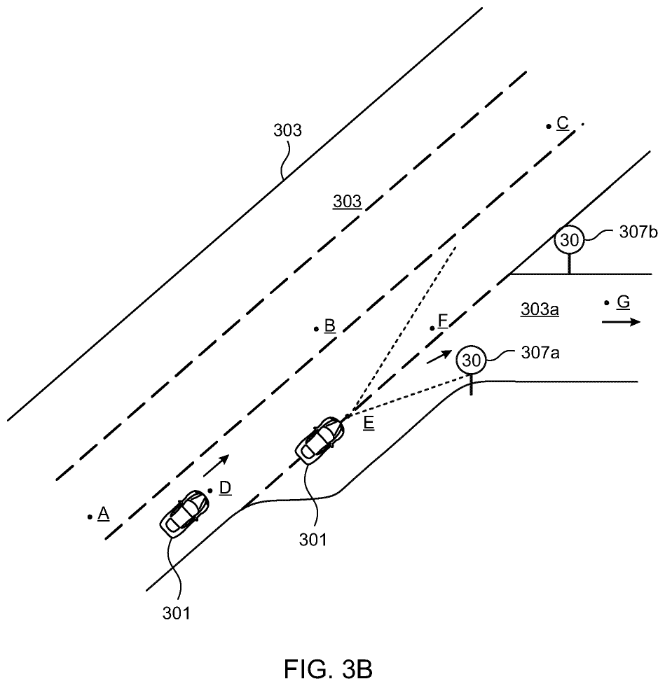

FIGS. 3A-3B illustrates an exemplary scenario 300 of a working example of the system 101 for validating path data for a main link path or a second link, in accordance with an example embodiment. A vehicle 301 (such as the user equipment 105a as illustrated in FIG. 1, hereinafter, the vehicle 301 is same as user equipment 105a) may be travelling on a main link 303 which diverges into a second link 303a. In some example embodiments, the main link 303 and the second link 303a may be any two links that are diverging from a common start location. For example, but not limited to, the second link 303a may be a ramp link, a transition from a highway to a local road, a turnabout or the like. One or more traffic objects 307a and traffic object 307b may be posted for the second link 303a. In an example embodiment, the traffic objects 307a and 307b may be posted on the main link 303. A location 305a may represent the real or satellite imagery based start location of the second link 303a and a location 305b may represent the start location of the second link 303a that may be stored in or extracted from the map database 103a.

According to one example embodiment, the vehicle 301 may encompass the main link 303 as a part of the route to be traversed. In an embodiment, the main link 303 may encompass a diverging link (i.e. the second link 303a). In another embodiment, while on the way to destination, the location of the vehicle 301 may be between the real start location 305a of the second link 303a and map data start location 305b of the second link 303a, that means the vehicle 301 may be already on the second link 303a but according to the map database 103a the vehicle 301 may still be projected to be on the main link 303. Accordingly, the vehicle 301 may detect the speed signs 307a and 307b for the main link 303a. And the vehicle 301 may wrongly capture the traffic objects 307a and 307b posted for the second link 303a to be for the main link 303. In an example embodiment, the vehicle 301 may capture the traffic objects 307a and 307b posted on the main link 303 for the second link 303a. In some examples, the vehicles running on the second link 303a may be able to capture the traffic objects 307a and 307b, but still report them wrongly as being associated with the main link 303 due to GPS errors. Hence, it is important to validate the correct path for the vehicle 301, and accordingly to assign the traffic object for the correct path, whether it is the main link 303 or the second link 303a.

Similarly, in FIG. 3B, the traffic objects 307a and 307b may be located on the link start of the second link 303a. The main link 303 and the second link 303a may comprise a plurality of sub-links, such as sub-links defined by a start node A, an intermediate node B, an end node C, and locations points D, E, F and G. In an embodiment, an upstream heading/driving direction of the link 303 may be the heading of the start node A of the link 303, measured as the heading of the vector formed by the start node A and the nearest shape point location (not shown in the figure). Similarly, the downstream heading/driving direction may be the heading of the end node C of the link 303, measured as the heading of the vector formed by the nearest shape point location of the end node C and the end node C. Therefore, the sub-link from start node A to intermediate node B may represent upstream map-matched link of the main link 303 and the sub-link from intermediate node B to end node C may represent downstream map-matched link of the main link 303. In an embodiment, the plurality of location points such as location point D, location point E, location point F, and location point G may represent plurality of path locations and the vectors associated with these locations may represent the driving direction of the vehicle 301.

In some example embodiment, the one or more sensors in the vehicle 301 travelling on the main link 303 (such as at location point E) may detect all the traffic objects (e.g. traffic object 307a and traffic object 307b) falling in field of view or sight of the vehicle 301. And therefore the vehicle may wrongly detect the traffic object 307a and the traffic object 307b for the main link 303. And the system 101 may identify wrong link for the traffic objects 307a and 307b.

In some example embodiments, the system 101 may provide measures for identifying correct path (e.g., one of the main link 303 or the second link 303a) for the traffic objects 307a and 307b. Alternately, the system 101 may be invoked on demand to identify and validate the correct path for the traffic objects 307a and 307b that have already been learnt and thereby update the map data for the traffic objects 307a and 307b. Irrespective of the manner in which the system 101 is triggered, the system 101 may provide measures for validating the path for the traffic object or the speed sign.

On being triggered, the system 101 may obtain at least one traffic object observation in the region associated with the main link 303. In some example embodiments, the traffic object observation may be received from the OEM cloud 109 over the network 107. In some example embodiments, the traffic object observation may be directly received from the vehicle 301 itself. The traffic object observations may include observations associated with one or more traffic objects on the main link 303, one or more pedestrians, one or more road signs, trees, building, roads, and any object present on the roads. In some example embodiments, the traffic object observations may comprise one or more road sign type (such as a speed sign or a non-speed signs), a value of a road sign if the sign type is the speed sign, links associated with respective speed signs, a location of the respective speed signs, driving direction of the links associated with speed signs, a heading of the traffic object, a location of the traffic object, a timestamp associated with capture of the traffic object and the like.

In some example embodiment, the traffic object observations may refer to sensor data collected from a vehicle (e.g., the vehicle 301, and/or other vehicles which have traversed the main link 303), that is, the one or more sensors installed in the vehicle 301. Such traffic observations may indicate the traffic objects as learned traffic objects which may be learned by the one or more sensors. In one example embodiment, the traffic object observations may include speed sign observations that comprise a time of capture of the traffic object or speed signs from the vehicle 301 which has already traversed the road 303. The system 101 may extract plurality of path locations for a traffic object observation (e.g., each of the traffic object 307a and the traffic object 307b) when the vehicle passes by the location of each of the traffic objects on its path. In an example embodiment, when the traffic object is captured by plurality of vehicles, the system 101 may extract different path locations for each vehicle.

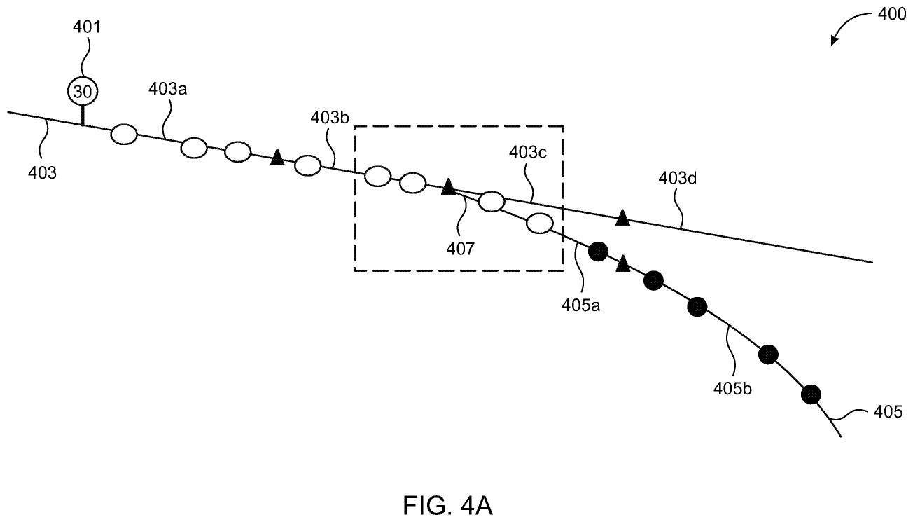

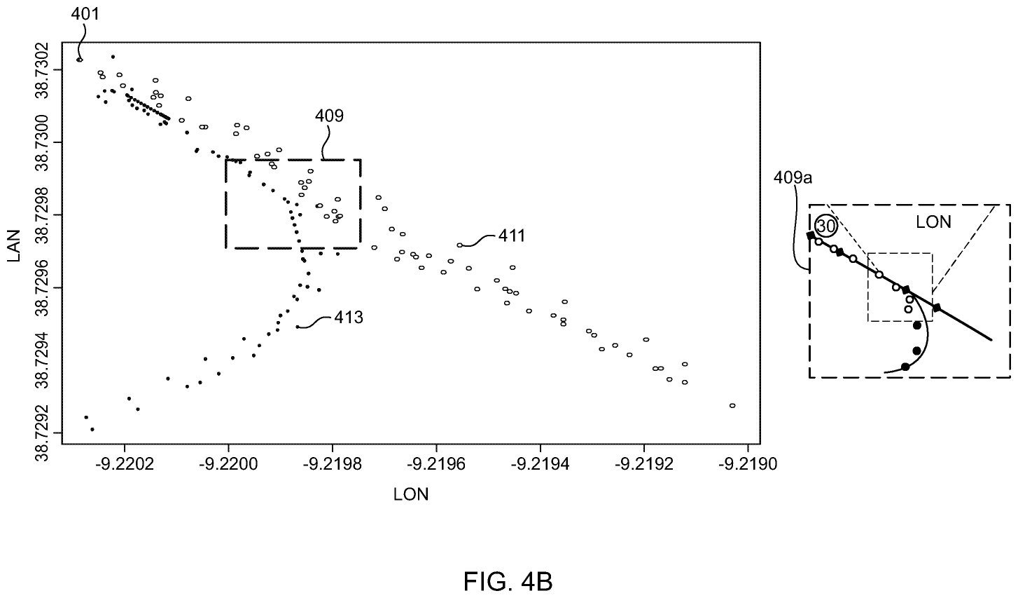

Also, each path location in plurality of path locations is different from other path locations based on vector direction, location data, heading data, driving direction, sign value, and time of capture of the traffic object from a vehicle. In an example embodiment, the system 101 may collect path locations of traffic object as input data. The system 101 then process, and execute the input data to validate the path data for the main link path based on one or more features as disclosed in FIGS. 4A-4B.

FIGS. 4A-4B illustrates an exemplary representation 400 of plurality of path locations associated with a traffic object observation, in accordance with an example embodiment. A traffic object 401 may be located on a main link 403 and the main link 403 further diverges in a second link 405. The main link 403 may further comprise first sub link 403a, second sub link 403b, third sub link 403c and fourth sub link 403d and the second link 405 may further comprise links fifth sub link 405a and sixth sub link 405b. And a first location 407 may be the common start location of the main link 403 and the second link 405.

In some example embodiment, the sensors in a vehicle, such as the vehicle 105 (which may be any of the user equipment 105a or 105b) may capture the traffic object 401 and the system 101 may receive the traffic object observation based on a first distance threshold from the first location 407. For example, the vehicle 105 may be within 100 m from the first location 407, at the time of receiving the traffic object observation. The distance threshold of 100 m is mentioned here only for exemplary purpose. It may be well understood by those of ordinary skill in the art that any configurable value for the first distance threshold may be specified, without deviating from the scope of the invention. In an example embodiment, the system 101 may receive the traffic object observation only if the location of the traffic object 401 from the first location 407 is within a distance of 100 meters. The system 101 may extract the plurality of path locations traversed by the vehicle 105 after capturing the traffic object 401. In an example embodiment, the system 101 may extract the sensor data of the vehicle 105 based on the path traversed by the vehicle 105.

Further, the system 101 may extract the path locations based on one or more criterions. In an example embodiment, based on one or more criterions, the extraction of path locations may be based on a distance threshold, or a time threshold, or combination thereof. In an example embodiment, a first criterion for extraction of path locations may be specified based on time. And the system 101 may extract the path locations of the vehicle 105 for a threshold time period before and after the detection of traffic object 401 by the vehicle 105, that is, from the time of receiving the traffic object observation. In an example embodiment, the threshold time period may be 30 seconds before and 30 seconds after the detection of traffic object 401. Further a second criterion for extraction of the path location may be based on time and distance. Further, the system 101 may extract the path locations of the vehicle 105 for a threshold time period before the detection of traffic object and for a threshold distance after the first location 407 (that is the common start location of the main link 403 and the second link 405).

In some example embodiments, the first criterion may comprise determining that the extracted pluralities of path locations are within a first time threshold and a second time threshold. The first time threshold may comprise a first predetermined time interval elapsed before a time of receiving the traffic object observation and the second time threshold comprises the first predetermined time interval elapsed after the time of receiving the traffic object observation. For example, if the first predetermined time interval is set to 30 seconds, then based on the first criterion specified above, the plurality of path locations of the vehicle 105 that are traversed 30 seconds before and 30 seconds after receiving the traffic object observation may be extracted.

In some example embodiments, the first criterion may comprise determining that the extracted plurality of path locations are within a first distance threshold and a second distance threshold. The first distance threshold comprises a first predetermined distance traversed before receiving the traffic object observation and the second distance threshold may comprise a second predetermined distance traversed after receiving the traffic object observation.

In some example embodiments, the second criterion comprises determining that the extracted plurality of path locations are within the first distance threshold and a second time threshold, wherein the second time threshold comprises a second predetermined time interval elapsed after the sensor location matches the first location.

In some example embodiments, the second criterion may comprise determining that the extracted pluralities of path locations are within the first time threshold and a second distance threshold. The second distance threshold may comprise a second predetermined distance measured from the first location 407.

In some example embodiments, the second criterion comprises determining that the extracted pluralities of path locations are within the first time threshold and the second time threshold. The second time threshold may comprise a second predetermined time interval elapsed after the sensor location matches the first location 407. That is, the second predetermined time interval elapsed after the vehicle 105 crosses the first location 407.

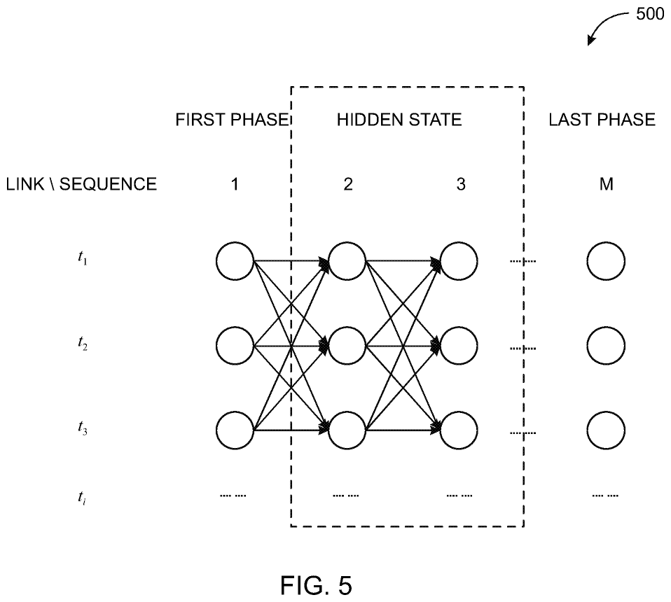

In some embodiments, the selection of the first criterion and the second criterion may be done in such a manner so as to receive the maximum number of path locations. Further, the system 101 may determine the association between the plurality of path locations based on a statistical model disclosed in FIG. 5. Based on the statistical model, the system 101 may determine if the plurality of path locations is connected to each other or not. Based on the connectivity of the path locations, the system 101 may determine if the second sub link 403b is connected to third sub link 403c (that is on the main link 403) or fifth sub link 405a (that is on the second link 405). Further, the system 101 may generate a trajectory based on the connectivity of the path locations and links. Based on the generated trajectory, the system 101 may determine if the path locations are associated with the main link 403 or the second link 405. Further, the system 101 may validate the path data for the main link 403 and the second link 405.

Similarly, in FIG. 4B, the system 101 may extract a plurality of path locations after detecting the traffic object 401. In an example embodiment, the system 101 may generate any one of a first trajectory 411 or a second trajectory 413 after detecting the traffic object 401. In an embodiment, the system 101 may extract the plurality of path locations on the main link 403 if the vehicle 105 traverses on the main link 403. The system 101 may determine the connectivity based on the path locations and generate the first trajectory 411. Similarly, the system 101 may extract the plurality of path locations on the second link 405 if the vehicle 105 traverses on the second link 405 after detecting the traffic object 401. The system 101 may determine the connectivity based on the path locations and generate the second trajectory 413. In an embodiment, the first trajectory 411 and the second trajectory 413 are determined based on the connectivity of the path locations of the vehicle 105 as illustrated in the bounding box 409. In an embodiment, the connectivity of the path locations in the bounding box 409 is determined using statistical model as disclosed in FIG. 5. In an embodiment, the bounding box 409a may represent zoomed in version of the plurality of path locations on the main link 403 and the second link 405 after detecting the traffic object 401.

FIG. 5 illustrates a statistical model 500 for determining an association between the pluralities of path locations, in accordance with an example embodiment. The system 101 may determine an association between the plurality of path locations based on a statistical model, and the association is determined based on a connectivity probability value, a directional probability value, or a combination thereof. The system 101 may determine a plurality of map-matched links associated with the plurality of path locations based on the map data. In an embodiment, the plurality of map-matched links comprises a first map-matched link and a second map-matched link. The system 101 may determine a connecting probability value between plurality of path locations based on connectivity of the first map-matched link and the second map-matched link associated with the statistical model 500. In an example embodiment, the statistical model 500 may be a statistical markov model (such as a Hidden Markov model). The term “Hidden Markov model” may be a probabilistic graphical model to predict a sequence of unknown hidden variables from a set of observed variables. The markov model may be a stochastic model used to model randomly changing systems. The hidden markov model may be a statistical markov model in which a system (e.g., the system 101) being modeled may be associated with a sequence of possible events in which a probability of each event depends only on a state attained in a previous event.

In an example embodiment, the map-matched links of path locations may not be connected and there is a sequence of connecting links in between. In the statistical model 500, the system 101 models the state as a set of links within a distance threshold to the start location 407 of the second link 405. In an example embodiment, the distance threshold value is set at 100 meters. The system 101 may determine downstream connecting links from an existing upstream link in “one phase”. In an embodiment, a phase may correspond to a point and it may have multiple possible links and the phase may represent multiple map-matched links. In FIG. 5, the system 101 may assume that there are at least M connecting links on the main link 403 and the second link 405, accordingly there may be M phases between a first phase and a last phase. A value of number “M” may be as large as the total number of links in the state S, which builds up heavy but unnecessary workloads. To solve this problem, in statistical model 500, the number M may be determined based on the number of connecting links based on one or more criterion (as discussed in FIGS. 4A-4B for which the vehicle locations are captured.

Further, the system 101 may characterize the state in each phase by a probabilistic approach using the statistical model 500. The emission probability for two learned traffic objects in the candidate is defined as the probability of the map-matched links: the larger-value sign is defined as S¹ while the smaller-value sign is as S^{M}. In Eq. 1, tᵢ₁ represents the ith link in Phase 1, α₁ represents the larger-value learned sign, and a₂ represents the smaller-value learned sign in the candidate.

P¹(tᵢ₁)=P(α₁|tᵢ₁)

P^{M}(t_{iM})=P(α₂|t_{iM}) (1)

In the statistical model 500, the transition between phases also follows a probabilistic approach and a certain connecting probability. The statistical model 500 further determines the connecting probability based on a function of the one or more transition probability values. The one or more transition probability values may include one or more of a first transition probability, or a second transition probability. The first transition probability value is associated with a connectivity feature of the links in a phase. The system 101 may measure the connectivity between links using the statistical model 500. The system 101 may assume that the transition between each phase in connectivity is predefined in the map and the transition is independent of each other. The statistical model 500 may define two links as connected if probability is equal to 1 and disconnected if probability is equal to 0. In Eq. 2, P^{c}(tⱼ|t₍ⱼ₋₁₎) denotes the connectivity transition probability from a link (state) in (j−1)th phase to a link in the jth phase. The probability allows the transition within the same link by setting the condition (pⱼ=qⱼ₋₁ or pⱼ=pⱼ₋₁). This is to retain the route whose number of connecting links is smaller than M (maximum number of connecting links) by giving a high connectivity transition probability for that route.

$${P}^{c} ( {t}_{j} \vert {t}_{1} ) = {P}^{c} ( {t}_{j} \vert {t}_{( j - 1 )} ) {P}^{c} ( {t}_{( j - 1 )} \vert {t}_{( j - 2 )} ) … … {P}^{c} ( {t}_{2} \vert {t}_{1} ) = {\prod }_{2}^{j} {P}^{c} ( {t}_{x} \vert {t}_{( x - 1 )} ) \\ where \\ {P}^{c} ( {t}_{j} \vert {t}_{( j - 1 )} ) = \{ \begin{matrix}1 & {p}_{j} = {q}_{j - 1} or {p}_{j} = {p}_{j - 1} \\ 0 & {p}_{j} \neq {q}_{j - 1} and {p}_{j} \neq {p}_{j - 1}\end{matrix} \qquad ( 2 )$$

The second transition probability value may be associated with a driving direction change feature of the map-matched link. The second transition probability may be measured based on the driving direction change between two connecting links (two phases). Based on a realization that the links associated with a traffic object usually have similar driving direction, their map-matched links and connecting links in between may also have similar driving direction. The transition probability employs the exponential function and it is used to maximize the probability with smallest driving direction change. In Eq. 3, P^{H}(t₍ⱼ₋₁₎|t₍ⱼ₋₂₎) denotes the driving direction transition probability from a link(state) in (j−1)th phase to a link in the jth phase. β is a parameter to resemble the largest driving direction change in the connecting links. In an example embodiment, the value is set to be 40 degrees.

$${P}^{H} ( {t}_{j} \vert {t}_{1} ) = {P}^{H} ( {t}_{j} \vert {t}_{( j - 1 )} ) {P}^{H} ( {t}_{( j - 1 )} \vert {t}_{( j - 2 )} ) … … {P}^{H} ( {t}_{2} \vert {t}_{1} ) = \frac{1}{β} {e}^{- \frac{{\sum }_{2}^{j} \vert {u}^{x - 1} - {u}^{x} \vert}{β}} \qquad ( 3 )$$

For example, each path location from the plurality of path locations described in FIGS. 4A-4B may correspond to a phase in the model described above. Further, each phase may have many possible links associated with it. Also, between any two phases, such as between a first phase and a second phase, there may be a plurality of unknown phases. These unknown phases may correspond to the hidden states of the Markov model discussed above. However, it may be possible to discover the connectivity of links in the hidden states based on the transition probabilities discussed above, which include a transition connectivity probability and a transition directional probability value. In some embodiments, the transition connectivity probability value may be determined based on connectivity of the plurality of map-matched links associated with the first phase and the second phase. Further, the transition directional probability value may be determined based on a degree of change in driving direction between the plurality of map-matched links associated with the first phase and the second phase. The transition direction probability value and the transition connectivity probability value may be used to determine a direction probability value and a connectivity probability value respectively. Also in some embodiments, the direction probability value and the connectivity probability value may define a combined transition probability for each phase. Further each link may have an emission probability value associated with it, as described earlier. This emission probability value may be determined for each of the plurality of map-matched links associated with the first phase and the second phase based on a location value and a heading value of the corresponding path location associated with each of the first phase and the second phase.

Based on the emission probability and the transition probability, all sets of the connecting links may be extracted. In an embodiment, the connecting links with P¹(t₁)P^{c}(t_{M}|t₁)P^{H}(t_{M}|t₁)P^{D}(t_{M}|t₁)P^{M}(t_{iM})≠0 may be proved to connect to a true route and may be taken as the validated path. In some example embodiments, the system 101 may validate the connectivity of the links and identify the correct path associated with the traffic object.

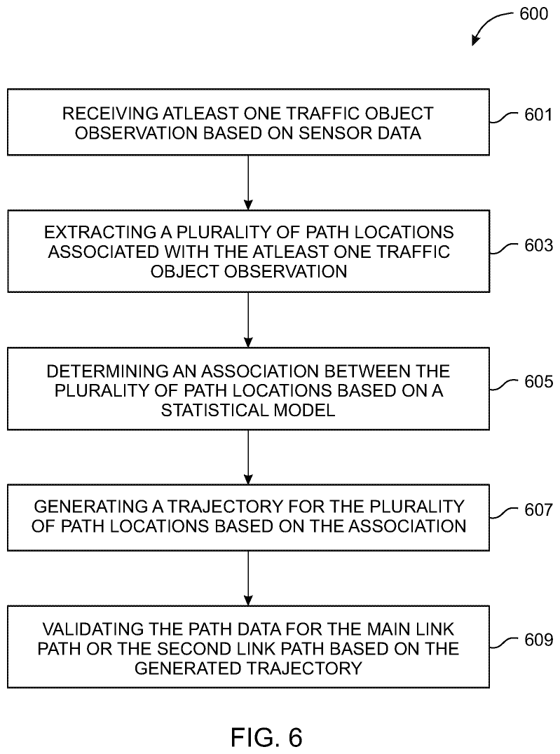

FIG. 6 illustrates a flow diagram of a method 600 for validating path data for a main link path or a second link, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 6 is for validating path data for a main link path or a second link. Fewer, more, or different steps may be provided.

At step 601, the method comprises receiving at least one traffic object observation based on sensor data. The traffic object observations comprise one or more speed signs, values of the respective speed signs, location and driving direction associated with the respective speed signs. The at least one traffic object observation is observed by one or more vehicles traversed a particular traffic object.

At step 603, the method comprises extracting a plurality of path locations associated with the at least one traffic object observation. The system 101 extracts plurality of path locations traversed by a vehicle associated with traffic object, based on one or more threshold criterion, such as a first criterion and a second criterion as discussed.

At step 605, the method comprises determining, an association between the pluralities of path location based on a statistical model. The system 101 may determine association of plurality of path locations based on one or more of a connectivity probability value, or a direction probability value. The system 101 may utilize the statistical model 500 (such as the hidden markov model) to determine the association between the plurality of path location. Towards this objective, the method may further comprise determining map-matched links associated with the plurality of path locations based on the map data. The plurality of map-matched links may be associated with a first phase and a second phase. Each phase may correspond to a point or a location from the plurality of path locations. The method may further comprise determining a transition connectivity probability value based on connectivity of the plurality of map-matched links associated with the first phase and the second phase. The method may further comprise determining a transition directional probability value based on a degree of change in driving direction between the pluralities of map-matched links associated with the first phase and the second phase. Additionally, the method may include determining an emission probability value for each of the plurality of map-matched links associated with the first phase and the second phase based on a location value and a heading value of the corresponding path location associated with each of the first phase and the second phase. Further, the method may include determining the connectivity probability value based on the transition connectivity probability value and determining the directional probability value based on the transition directional probability value. Finally, the method comprises determining the association between the plurality of path locations based on a function of the emission probability value, the connectivity probability value and the directional probability value and the function is provided by the statistical model 500.

At step 607, the method comprises generating a trajectory for the plurality of path locations based on the association. The trajectory comprises either one of the main link path and a second link path. For example, the system 101 may use the HMM discussed in FIG. 5 to derive an association between plurality of path locations depicted in FIGS. 4A-4B to generate one of the two trajectories 411 or 413. At step 609, the method comprises validating the path data for the main link path or the second link path, based on the generated trajectory. For example, if the generated trajectory is 411, the path associated with the main link 403 may be determined as the valid path. Accordingly, the traffic object 401 may be associated with the main link 403. Similarly, if the generated trajectory is 413, the path associated with the second link 405 may be determined as the valid path. Accordingly, the traffic object 401 may be associated with the second link 405. The system 101 validate if the traffic objects are associated with the main link 403 or the second link 405. The method further comprises updating the map data of the region based on the validated path data of the main link path and the second link path. The method further comprises sending notifications or updates of the validated path data to the cloud or the vehicle.

The method 600 may be implemented using corresponding circuitry. For example, the method 600 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 900.

In an example embodiment, an apparatus for performing the method 600 of FIG. 6 above may comprise a processor (e.g. the processor 201) configured to perform some or each of the operations of the method of FIG. 6 described previously. The processor may, for example, be configured to perform the operations (601-609) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (601-609) may comprise, for example, the processor 201 which may be implemented in the system 101 and/or a device or circuit for executing instructions or executing an algorithm for processing information as described above.

In this way, example embodiments of the invention result in validating path data for a main link path or a second link. The validated path data for the main link or second link may provide accurate and reliable navigation assistance. The validated path data in case of transition from highway to a ramp, or turnabouts or vice versa makes the navigation accurate and provide correct path information for the road signs on such links and avoids the erroneous information. Alternatively, validated path data may be used for updating the map database. Therefore, embodiments of the present disclosure may provide improvements in the map database and/or the navigation assistance provided using such map data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for validating path data for a main link path or a second link path, the method comprising:
receiving at least one traffic object observation based on sensor data;
extracting a plurality of path locations associated with the at least one traffic object observation;
determining, based on a statistical model, an association between the plurality of path locations, wherein the association is determined based on a connectivity probability value, a directional probability value, or a combination thereof;
generating a trajectory for the plurality of path locations based on the association, wherein the trajectory comprises either one of the main link path and the second link path; and
validating the path data for the main link path or the second link path based on the generated trajectory.

2. The method of claim 1, further comprising determining that a sensor location associated with the traffic object observation is within a first distance threshold of a first location.

3. The method of claim 2, wherein the first location is associated with a starting location of at least one of the main link path and the second link path.

4. The method of claim 3, wherein extracting the plurality of path locations comprises:
extracting the plurality of path locations associated with the traffic object observation based on at least one of a first criterion and a second criterion.

5. The method of claim 4, wherein the first criterion comprises determining that the extracted plurality of path locations are within a first time threshold and a second time threshold,
wherein the first time threshold comprises a first predetermined time interval elapsed before a time of receiving the traffic object observation; and
wherein the second time threshold comprises the first predetermined time interval elapsed after the time of receiving the traffic object observation.

6. The method of claim 5, wherein the second criterion comprises determining that the extracted plurality of path locations are within the first time threshold and a second distance threshold,
wherein the second distance threshold comprises a second predetermined distance measured from the first location.

7. The method of claim 1, further comprising updating a map database based on the validated path.

8. The method of claim 1, further comprising assigning a traffic object associated with the traffic object observation to one of the main link path or the second link path based on the validation.

9. The method of claim 1, wherein the statistical model is a Hidden Markov Model.

10. The method of claim 9, wherein determining the association between the plurality of path locations further comprises:
determining a plurality of map-matched links associated with the plurality of path locations based on map data, wherein the plurality of map-matched links are associated with a first phase and a second phase, wherein each of the first phase and the second phase correspond to a path location from the plurality of path locations;
determining a transition connectivity probability value based on connectivity of the plurality of map-matched links associated with the first phase and the second phase;
determining a transition directional probability value based on a degree of change in driving direction between the plurality of map-matched links associated with the first phase and the second phase;
determining an emission probability value for each of the plurality of map-matched links associated with the first phase and the second phase based on a location value and a heading value of the corresponding path location associated with each of the first phase and the second phase;
determining the connectivity probability value based on the transition connectivity probability value;
determining the directional probability value based on the transition directional probability value; and
determining the association between the plurality of path locations based on a function of the emission probability value, the connectivity probability value and the directional probability value, wherein the function is provided by the statistical model.

11. A system for validating path data for a main link path or a second link path, the system comprising:
a memory configured to store computer-executable instructions; and
one or more processors configured to execute the instructions to:
receive, at least one traffic object observation, based on sensor data;
extract, a plurality of path locations associated with the at least one traffic object observation;
determine, based on a statistical model, an association between the plurality of path locations, wherein the association is determined based on a connectivity probability value, a directional probability value, or a combination thereof;
generate, a trajectory for the plurality of path locations based on the association, wherein the trajectory comprises either one of the main link path and the second link path; and
validate, the path data for the main link path or the second link path based on the generated trajectory.

12. The system of claim 11, wherein the one or more processors are further configured to determine that a sensor location associated with the traffic object observation is within a first distance threshold of a first location.

13. The system of claim 12, wherein the first location is associated with a starting location of at least one of the main link path and the second link path.

14. The system of claim 13, wherein to extract the plurality of path locations the one or more processors are further configured to:
extract the plurality of path locations associated with the traffic object observation based on at least one of a first criterion and a second criterion.

15. The system of claim 14, wherein the first criterion comprises determining that the extracted plurality of path locations are within a first distance threshold and a second distance threshold,
wherein the first distance threshold comprises a first predetermined distance traversed before receiving the traffic object observation; and
wherein the second distance threshold comprises a second predetermined distance traversed after receiving the traffic object observation.

16. The system of claim 15, wherein the second criterion comprises determining that the extracted plurality of path locations are within the first distance threshold and a second time threshold,
wherein the second time threshold comprises a second predetermined time interval elapsed after the sensor location matches the first location.

17. The system of claim 11, further comprising assigning a traffic object associated with the traffic object observation to one of the main link path or the second link path based on the validation.

18. The system of claim 11, wherein the statistical model is a Hidden Markov Model.

19. The system of claim 18, wherein to determine the association between the plurality of path locations the one or more processors are further configured to:
determine a plurality of map-matched links associated with the plurality of path locations based on map data, wherein the plurality of map-matched links are associated with a first phase and a second phase, wherein each of the first phase and the second phase correspond to a path location from the plurality of path locations;
determine a transition connectivity probability value based on connectivity of the plurality of map-matched links associated with the first phase and the second phase;
determine a transition directional probability value based on a degree of change in driving direction between the plurality of map-matched links associated with the first phase and the second phase;
determine an emission probability value for each of the plurality of map-matched links associated with the first phase and the second phase based on a location value and a heading value of the corresponding path location associated with each of the first phase and the second phase;
determine the connectivity probability value based on the transition connectivity probability value;
determine the directional probability value based on the transition directional probability value; and
determine the association between the plurality of path locations based on a function of the emission probability value, the connectivity probability value and the directional probability value, wherein the function is provided by the statistical model.

20. A computer programmable product comprising a non-transitory computer readable medium having stored thereon computer executable instruction which when executed by one or more processors, cause the one or more processors to carry out operations for validating path data for a main link path or a second link path, the operations comprising:
receiving at least one traffic object observation based on sensor data;
extracting a plurality of path locations associated with the at least one traffic object observation;
determining, based on a statistical model, an association between the plurality of path locations, wherein the association is determined based on a connectivity probability value, a directional probability value, or a combination thereof;
generating a trajectory for the plurality of path locations based on the association, wherein the trajectory comprises either one of the main link path and the second link path; and
validating the path data for the main link path or the second link path based on the generated trajectory.
